(19) United States
(12) Patent Application Publication
(10) Pub. No.: US 2005/0067250 A1
(43) Pub. Date: Mar. 31, 2005

(54) Coupling assembly with actuator lever system

(75) Inventors: Mark A. Willett, Midland, MI (US); Dennis P. Berryhill, Remus, MI (US); Michael T. Doherty, Midland, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 10/671,170

(22) Filed: Sep. 25, 2003

(51) Int. Cl. F16D 13/54

(52) U.S. Cl. 192/70.3; 192/99 A

(57) ABSTRACT

A coupling assembly includes a housing disposed about an axis and having a retainer. The assembly further includes a coupling pack disposed about the axis, and an actuator lever having an end engaged with the retainer of the housing such that the actuator lever is pivotable with respect to the housing for applying an axial force on the coupling pack. Moreover, the retainer inhibits axial movement of the end of the actuator lever.

### BACKGROUND OF THE INVENTION

1. Field of the Invention

The invention relates to a mechanically applied coupling assembly, such as a clutch or brake.

2. Background Art

Various mechanically applied coupling assemblies are known. Examples of mechanically applied clutches, for instance, are disclosed in U.S. Pat. Nos. 6,332,514 and 4,630,720.

### SUMMARY OF THE INVENTION

A coupling assembly according to the invention includes a housing disposed about an axis and having a retainer. The assembly further includes a coupling pack disposed about the axis, and an actuator lever having an end engaged with the retainer of the housing such that the actuator lever is pivotable with respect to the housing for applying an axial force on the coupling pack. Moreover, the retainer inhibits axial movement of the end of the actuator lever.

Further under the invention, a coupling assembly includes a housing having an axis, a first housing portion and an annular second housing portion extending axially from the first housing portion. The second housing portion has multiple T-shaped apertures. In addition, the assembly includes a coupling pack disposed at least partially in the housing and multiple actuator levers that each have a main body and multiple T-shaped projections extending from the main body. Each projection extends into one of the apertures of the second housing portion such that each actuator lever is pivotable with respect to the housing for applying an axial force on the coupling pack. The apertures are configured to inhibit axial movement of the projections of the actuator levers. Furthermore, the assembly includes an actuator device for pivoting the actuator levers to apply the axial force on the coupling pack.

Still further under the invention, a coupling assembly includes an annular housing having an outer wall extending about a central axis. The outer wall includes inwardly extending formed splines positioned about the central axis and extending parallel thereto. A plurality of the inwardly extending splines each include a retainer opening. A coupling pack is received within the outer wall of the housing and extends about the central axis. The assembly further includes a plurality of actuator levers each of which has an outer end engaged with the retainer opening of an associated spline of the outer wall of the housing such that the actuator lever is pivotable with respect to the housing. Each actuator lever has an inner portion for applying an axial force on the coupling pack upon pivoting about its outer end.

A coupling assembly housing according to the invention for use with an actuator lever includes a first housing portion having an axis, and an annular second housing portion extending axially from the first housing portion. The second housing portion has a retainer for retainably receiving an end of the actuator lever while allowing pivotable movement of the actuator lever with respect to the housing. Furthermore, the retainer is configured to inhibit axial movement of the end of the actuator lever.

### BRIEF DESCRIPTION OF THE DRAWINGS

FIG. 1 is a front view of a coupling assembly according to the invention;

FIG. 2 is a cross sectional view of the coupling assembly taken along line 2-2 of FIG. 1 and viewed in the direction of the arrows, wherein the coupling assembly is shown in a disengaged position;

FIG. 3 is a cross sectional view of the coupling assembly taken along line 3-3 of FIG. 1 and viewed in the direction of the arrows, wherein the coupling assembly is shown in the disengaged position;

FIG. 4 is a cross sectional view of the coupling assembly showing the coupling assembly in an engaged position;

FIG. 5 is an exploded perspective view of the coupling assembly;

FIG. 6 is a fragmentary side view of a housing of the coupling assembly;

FIG. 7 is a perspective view of an actuator lever of the coupling assembly;

FIG. 8 is a front view of the actuator lever of FIG. 7;

FIG. 9 is a cross sectional view of the actuator lever taken along line 9-9 of FIG. 8 and viewed in the direction of the arrows; and

FIG. 10 is a front view of a second embodiment of an actuator lever according to the invention.

### DETAILED DESCRIPTION OF THE PREFERRED EMBODIMENT(S)

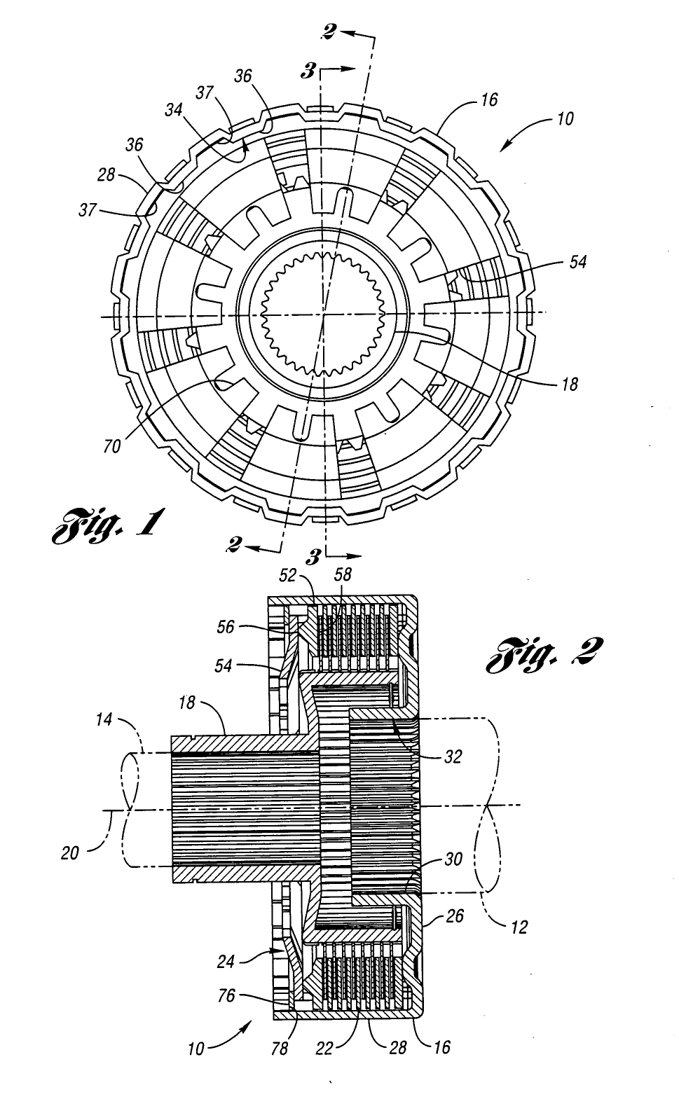

FIGS. 1-4 show a coupling assembly 10, such as a clutch or brake, for transmitting torque between two components, such as a first and second shafts 12 and 14, respectively. One shaft 12, 14 may be a drive shaft, and the other shaft 12, 14 may be a driven shaft such that both shafts are moveable. As another example, one of the shafts 12, 14 may be stationary.

Referring to FIGS. 1-5, the coupling assembly 10 includes first and second coupling assembly members, such as a coupling assembly housing 16 and a coupling assembly hub 18, that are coupled to the first and second shafts 12 and 14, respectively, and that share a common central axis 20. The coupling assembly 10 further includes a coupling pack 22, such as a clutch pack or brake pack, disposed between the housing 16 and the hub 18, and an actuator arrangement 24 for applying an axial load on the coupling pack 22 to couple together the housing 16 and the hub 18.

The housing 16 has a first housing portion 26 and an annular second housing portion 28 extending axially from the first housing portion 26. In the embodiment shown in the Figures, both housing portions 26 and 28 are of a thin wall construction and may be formed, for example, from stamped sheet metal. Alternatively, the housing 16 may comprise any suitable material and may be manufactured in any suitable manner.

The first housing portion 26 includes a hub portion 30 that is configured to be coupled to the first shaft 12. For example, the hub portion 30 may include a splined surface 32 that is configured to mate with a splined surface on the first shaft 12.

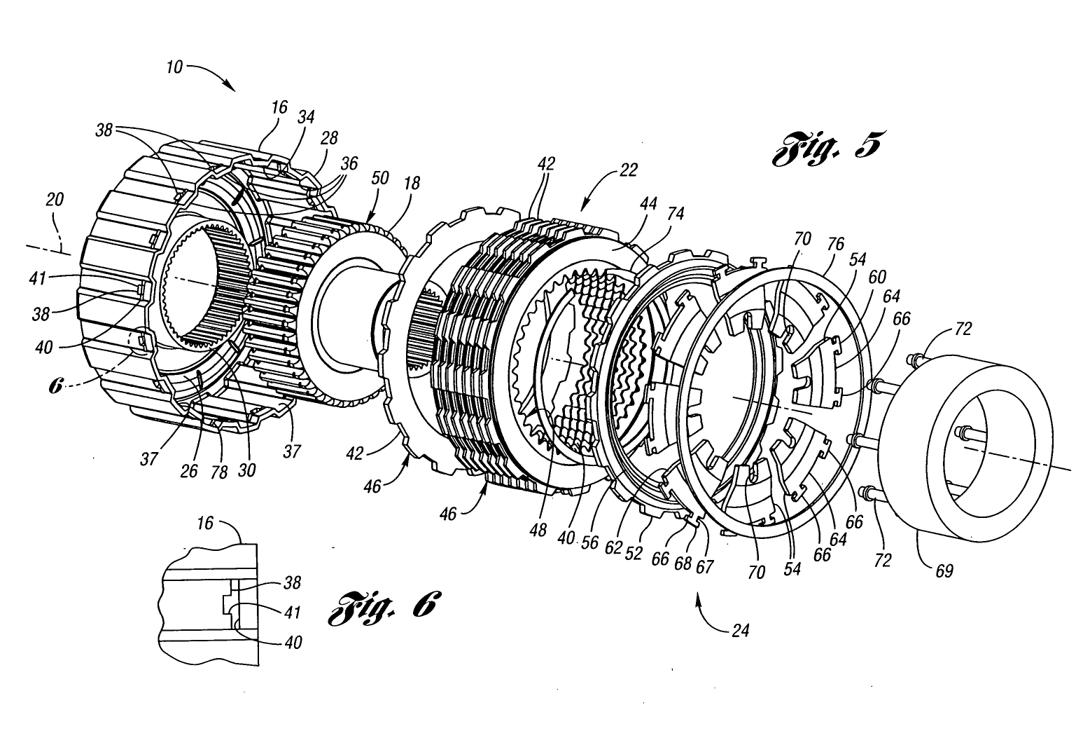

As shown in FIGS. 1 and 5, the second housing portion 28 has a splined surface 34 that includes multiple inwardly extending formed splines 36 positioned about the axis 20 and extending generally parallel thereto, and multiple recessed portions 37 that alternate with the splines 36. In the embodiment shown in FIG. 5, each spline 36 includes a retainer 38, such as a retainer aperture or opening, for inhibiting axial movement of at least a portion of the actuator arrangement 24 as explained below in detail. Furthermore, in the embodiment shown in FIGS. 5 and 6, each retainer 38 includes a first portion 40 having a first width transverse to the axis 20, and a second portion 41 extending axially from the first portion 40 and having a second width transverse to the axis 20, wherein the second width is less than the first width. For example, each retainer 38 may have a T-shaped configuration.

Alternatively, each retainer 38 may have any suitable configuration, such as a recess that does not extend through the second housing portion 28. Furthermore, the retainers 38 may be disposed at any suitable location on the housing 16. For example, each retainer 38 may be disposed on a recessed portion 37 of the second housing portion 28.

Still referring to FIG. 5, the coupling pack 22 is received within the second housing portion 28 and includes one or more first coupling members, such as first plates 42, and one or more second coupling members, such as second plates 44. Each first plate 42 has a splined outer surface 46 that engages the splined surface 34 of the second housing portion 28 of the housing 16 such that the first plates 42 are coupled to the housing 16. Each second plate 44 has a splined inner surface 48 that engages a splined surface 50 of the hub 18 such that the second plates 44 are coupled to the hub 18.

The actuator arrangement 24 is configured to apply an axial force or load on the coupling pack 22 to frictionally couple together the first and second plates 42 and 44, respectively. In the embodiment shown in FIGS. 2-5, the actuator arrangement 24 includes a force applicator member, such as applicator ring 52, and one or more actuator levers 54. The applicator ring 52 has a raised portion, such as ridge 56, that is engageable with the actuator levers 54, and an engaging surface 58 that is engageable with the coupling pack 22 and/or an intermediate member disposed between the applicator ring 52 and the coupling pack 22.

The actuator levers 54 are engaged with the housing 16 and are pivotable with respect to the housing 16 to apply an axial load on the applicator ring 52, to thereby apply an axial load on the coupling pack 22 and engage the coupling assembly 10. More specifically, referring to FIGS. 5 and 7-9, each actuator lever 54 has a first portion, such as an outer end 60, that is engaged with one or more retainers 38 of the housing 16, and a second portion, such as inner portion 62, that is engageable with the applicator ring 52 for applying an axial load on the applicator ring 52 upon pivoting about its outer end 60.

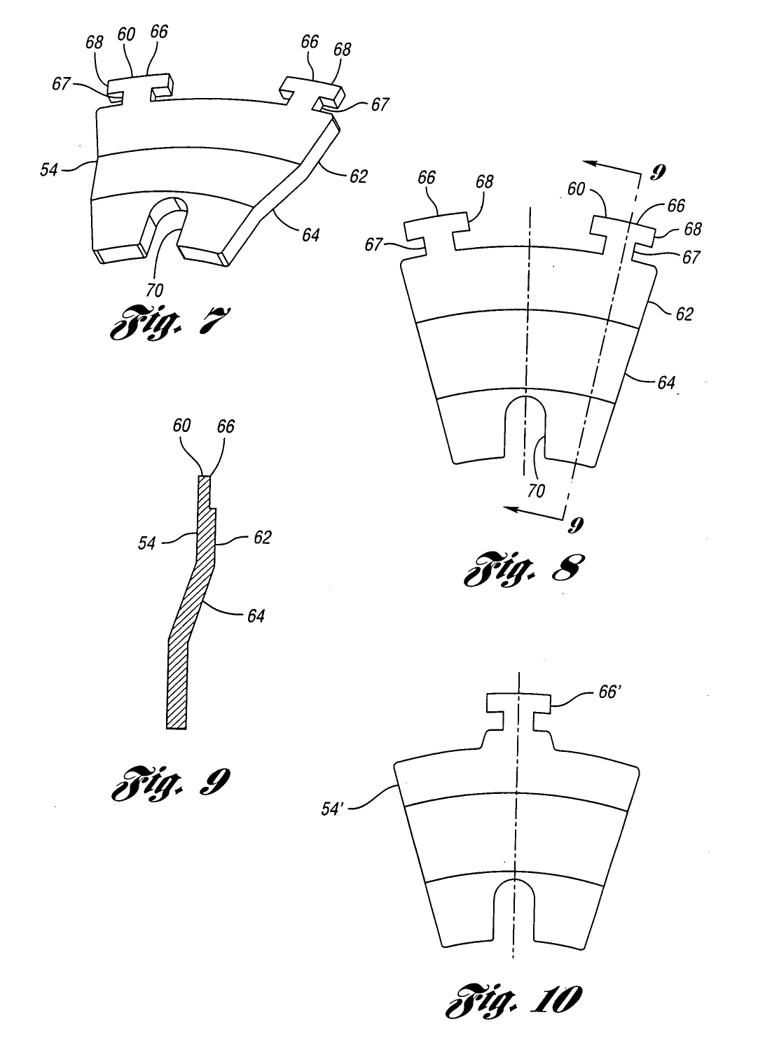

In the embodiment shown in FIGS. 5 and 7-9, for example, each actuator lever 54 includes a lever body 64 and one or more radially extending projections 66 that are each engaged with a retainer 38 of the housing 16. While the projections 66 may have any suitable shape, in the embodiment shown in FIGS. 5, 7 and 8, each projection 66 has a T-shaped configuration. More generally, referring to FIGS. 7 and 8, each projection 66 may have a first portion 67 having a first width, and a second portion 68 extending radially from the first portion 67 and having a second width greater than the first width. With such a configuration, referring to FIGS. 5 and 6, each projection 66 of a respective actuator lever 54 may first be inserted into the first portion 40 of a particular retainer 38, and then slid axially into the second portion 41 of the retainer 38 to directly attach the actuator lever 54 to the housing 16. Furthermore, during operation of the coupling assembly 10, each projection 66 may be retained in the second portion 41 of a respective retainer 38, such that the actuator levers 54 are allowed to pivot with respect to the housing 16 while axial movement of the projections 66 is inhibited.

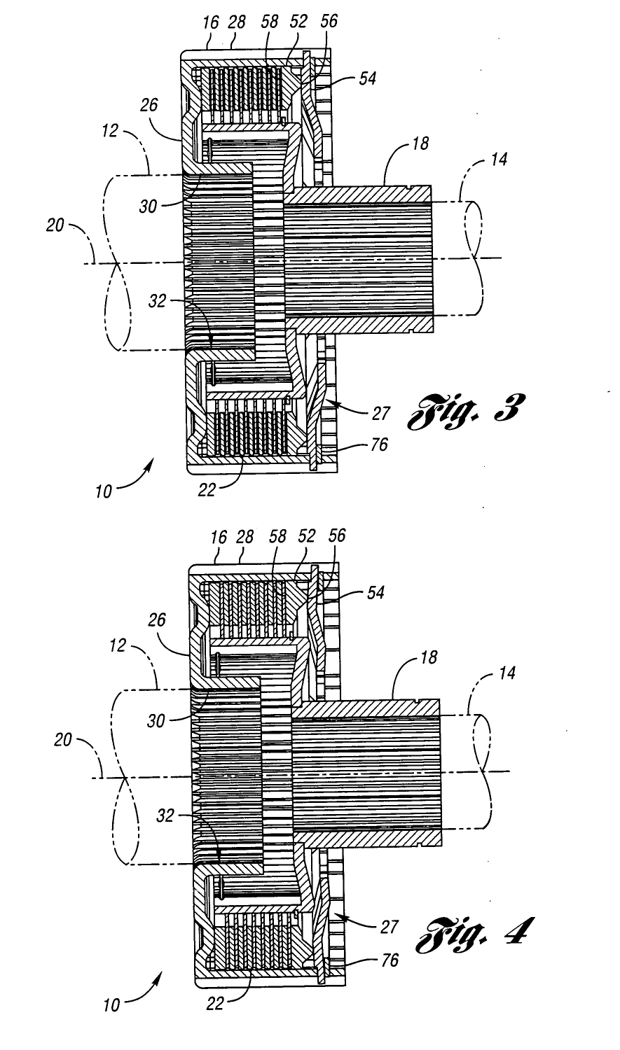

The actuator levers 54 are engageable with an actuator device, such as actuator 69, that is configured to apply an axial load on the actuator levers 54 to pivot each actuator lever 54 with respect to the housing 16 from a coupling assembly disengaged position, shown in FIGS. 2 and 3, to a coupling assembly engaged position, shown in FIG. 4. For example, in the embodiment shown in FIG. 5, each actuator lever 54 includes an engaging portion, such as an aperture 70, that is engageable with a moveable actuator finger or pin 72 of the actuator 69. Alternatively, the actuator levers 54 may be provided without apertures 70 if not required for a particular application. Moreover, the actuator 69 may be any suitable apparatus, such as a mechanical, electrical and/or hydraulic actuator.

With the configuration described above, the axial load applied on the applicator ring 52 by each actuator lever 54 may be significantly larger than the load applied to each actuator lever 54 by the actuator 69. For example, depending on the length of the actuator levers 54 and the location of the ridge 56 of the applicator ring 52, a three hundred percent load increase, or greater, may be achieved. Alternatively, the applicator ring 52 may be omitted and the actuator levers 54 may apply an axial load directly on the coupling pack 22 and/or to an intermediate member disposed between the coupling pack 22 and the actuator levers 54.

The coupling assembly 10 may also include one or more spacers and/or retaining members for spacing apart coupling assembly components and/or retaining together coupling assembly components. Referring to FIG. 5, for example, the coupling assembly 10 may include a spacer ring 74 disposed between the coupling pack 22 and the applicator ring 52, and a snap ring 76 for retaining the projections 66 of the actuator levers 54 in the second portions 41 of the retainers 38.

The snap ring 76 in this embodiment snaps into a groove 78 formed in the housing 16. The groove 78 is axially aligned with the first portions 40 of the retainers 38, such that the first portions 40 form part of the groove 78.

The coupling assembly 10 may be assembled in any suitable manner. For example, referring to FIG. 5, the coupling pack 22 may first be positioned on the hub 18. Next, the hub 18 and coupling pack 22 may be inserted into the housing 16. The spacer ring 74 and applicator ring 52 may then be positioned on the coupling pack 22. Next, the actuator levers 54 may be attached to the housing 16. More specifically, each projection 66 of a respective actuator lever 54 may first be inserted into the first portion 40 of a particular retainer 38 such that the second portion 68 of the projection 66 extends radially beyond an outer surface of the associated spline 36 of the housing 16. The respective actuator lever 54 may then be moved axially such that first portion 67 of each projection 66 slides into the second portion 41 of the retainer 38 to thereby attach the actuator lever 54 directly to the housing 16. This process may be repeated until all actuator levers 54 have been attached to the housing 16. Next, the snap ring 76, or other retaining member, may be inserted into the housing 16 to retain each projection 66 of each actuator lever 54 in the second portion 41 of a respective retainer 38.

Alternatively or supplementally, the actuator 69 may be used to sufficiently retain the projections 66 in the second portions 41 of the retainers 38. For example, the actuator pins 72 may remain engaged with the actuator levers 54 when each actuator lever 54 is in the coupling assembly engaged position and the coupling assembly disengaged position. With such a configuration, the snap ring 76 may be omitted if not required.

As mentioned above, use of the actuator levers 54 enables the axial load applied on the actuator ring 52 and coupling pack 22 to be increased significantly compared with the axial load applied on the actuator levers 54 by the actuator 69. Furthermore, because the actuator levers 54 are engaged directly with the housing 16 such that the housing 16 functions as a pivot point for each actuator lever 54, the coupling assembly 10 has a relatively simple yet robust design.

Referring to FIG. 10, a second embodiment 54′ of an actuator lever according to the invention is shown. The actuator lever 54′ includes a single projection 66′ that is configured to extend into an aperture formed in a coupling assembly housing (not shown). Alternatively, an actuator lever and housing according to the invention may be provided with any suitable configuration such that the actuator lever is pivotable with respect to the housing.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A coupling assembly comprising:
a housing disposed about an axis and having a retainer;
a coupling pack disposed about the axis; and
an actuator lever having an end engaged with the retainer of the housing such that the actuator lever is pivotable with respect to the housing for applying an axial force on the coupling pack, wherein the retainer inhibits axial movement of the end of the actuator lever.

2. The coupling assembly of claim 1 wherein the retainer comprises an aperture that extends through the housing, and the end of the actuator lever extends into the aperture.

3. The coupling assembly of claim 2 wherein a portion of the end of the actuator lever extends radially beyond an outer surface of the housing.

4. The coupling assembly of claim 3 wherein the end of the actuator lever comprises a T-shaped projection.

5. The coupling assembly of claim 2 wherein the aperture comprises a first portion having a first width transverse to the axis, and a second portion extending axially from the first portion and having a second width transverse to the axis, wherein the second width is less than the first width.

6. The coupling assembly of claim 5 wherein the first and second portions of the aperture cooperate to define a T-shaped opening.

7. The coupling assembly of claim 5 further comprising a retaining member for retaining a portion of the end of the actuator lever in the second portion of the aperture.

8. The coupling assembly of claim 1 wherein the retainer comprises first and second apertures that extend through the housing, and the actuator lever comprises first and second projections that extend into the first and second apertures, respectively.

9. The coupling assembly of claim 1 further comprising an actuator device for pivoting the actuator lever to apply the axial force on the coupling pack.

10. A coupling assembly comprising:
a housing having an axis, the housing including a first housing portion and an annular second housing portion extending axially from the first housing portion, the second housing portion having multiple T-shaped apertures;
a coupling pack disposed at least partially in the housing;
multiple actuator levers that each have a main body and multiple T-shaped projections extending from the main body, each projection extending into one of the apertures of the second housing portion such that each actuator lever is pivotable with respect to the housing for applying an axial force on the coupling pack, wherein the apertures are configured to inhibit axial movement of the projections of the actuator levers; and
an actuator device for pivoting the actuator levers to apply the axial force on the coupling pack.

11. A coupling assembly comprising:
an annular housing having an outer wall extending about a central axis, the outer wall of the housing including inwardly extending formed splines positioned about the central axis and extending parallel thereto, a plurality of the inwardly extending splines each including a retainer opening;
a coupling pack received within the outer wall of the housing and extending about the central axis; and
a plurality of actuator levers each of which has an outer end engaged with the retainer opening of an associated spline of the outer wall of the housing such that the actuator lever is pivotable with respect to the housing, each actuator lever having an inner portion for applying an axial force on the coupling pack upon pivoting about its outer end.

12. The coupling assembly of claim 11 wherein a portion of the outer end of each actuator lever extends radially beyond an outer surface of the outer wall of the housing.

13. The coupling assembly of claim 12 wherein the outer end of each actuator lever includes a T-shaped projection.

14. The coupling assembly of claim 13 wherein each retainer opening comprises a first portion having a first width transverse to the axis, and a second portion extending axially from the first portion and having a second width transverse to the axis, wherein the second width is less than the first width.

15. The coupling assembly of claim 14 wherein the first and second portions of each retainer opening cooperate to define a T-shaped opening.

16. The coupling assembly of claim 14 further comprising a retaining member for retaining a portion of the outer end of each actuator lever in the second portion of a respective retainer opening.

17. A coupling assembly housing for use with an actuator lever, the housing comprising:
a first housing portion having an axis; and
an annular second housing portion extending axially from the first housing portion, the second housing portion having a retainer for retainably receiving an end of the actuator lever while allowing pivotable movement of the actuator lever with respect to the housing, wherein the retainer is configured to inhibit axial movement of the end of the actuator lever.

18. The housing of claim 17 wherein the retainer comprises an aperture that extends through the second housing portion.

19. The housing of claim 18 wherein the aperture comprises a first portion having a first width transverse to the axis, and a second portion extending axially from the first portion and having a second width transverse to the axis, wherein the second width is less than the first width.

20. The housing of claim 18 wherein the aperture comprises a T-shaped opening.

21. The housing of claim 17 wherein the second housing portion comprises multiple retainers, each retainer being configured to retainably receive an end of an actuator lever while allowing pivotable movement of the actuator lever with respect to the housing, wherein the retainers are configured to inhibit axial movement of the ends of the actuator levers.
